(19) United States
(12) Patent Application Publication
(10) Pub. No.: US 2006/0207448 A1
(43) Pub. Date: Sep. 21, 2006

(54) Method for printing white on dark textiles using screen-printers and inkjet printers

(76) Inventors: Scott Otto Fresener, Scottsdale, AZ (US); S. Michael Fresener, Mesa, AZ (US)

Correspondence Address: ETHERTON LAW GROUP, LLC, 5555 E. VAN BUREN STREET, SUITE 100, PHOENIX, AZ, 85008, US

(21) Appl. No.: 11/414,634

(22) Filed: Apr. 27, 2006

Related U.S. Application Data
(63) Continuation-in-part of application No. 11/101,084, filed on Apr. 7, 2005.
(60) Provisional application No. 60/647,560, filed on Jan. 27, 2005.

(51) Int. Cl. B41F 15/04

(52) U.S. Cl. 101/115

(57) ABSTRACT

A method for printing light colors on dark substrates such as black textiles is disclosed. The method includes screen printing a pre-treatment onto a textile, inkjet printing an underbase on the textile, inkjet printing an image over the underbase, and counting and displaying the number of printings of the underbase and image. In the preferred embodiment, a pre-treatment is screen printed onto a black t-shirt, then a white, opaque underbase is inkjet printed onto the black t-shirt, and finally a white image is inkjet printed over the white underbase. In alternative embodiments, a white image is inkjet printed directly on the black t-shirt without any underbase or is inkjet printed over a screen printed underbase.

### CROSS-REFERENCE TO RELATED APPLICATIONS

This application claims the benefit of co-pending patent application Ser. No. 11/101,084 filed Apr. 7, 2005, claiming priority to co-pending provisional application 60/647,560 filed Jan. 27, 2005, co-pending provisional application No. 60/675,641 filed Apr. 27, 2005, and co-pending provisional application No. 60/774,585 filed Feb. 16, 2006.

### FIELD OF INVENTION

This invention generally relates to printing images onto articles of clothing and other textiles and substrates. This invention relates particularly to methods for inkjet printing light or white colors on dark textiles employing combinations of screen printing and inkjet printing.

### BACKGROUND

There are two preferred methods for printing images on substrates and, more particularly, on textiles. The older and more popular method is screen printing. A newer method is inkjet printing.

Screen printing is commonly used to print designs and other decorations on textiles such as t-shirts, shorts, underwear, towels, ball caps, and other clothing. These images are used for decoration or advertising and frequently include various logos or other types of decoration such as the name of a sports team or organization.

In order to screen print an image onto a textile, a stencil of the desired image is created on mesh fabric that has been stretched across a frame. The mesh stencil is placed over the article of clothing in preparation for printing. Ink is applied by squeegee to the stencil and is forced through holes in the mesh onto the textile, creating the image. The ink is cured after it has been applied to the textile.

Screen printing is typically carried out by using either a rotary press (also referred to as a “speed table”) or a single-item printing station. The rotary press is a base that has arms supporting several platens whereby each platen is capable of supporting an article of clothing during the screen printing process. The screen printing process includes various steps that are completed at certain stations. As the base rotates, each platen is moved from station to station and a different step in the screen printing process is completed. Each station may have a different function, such as loading, printing, curing, unloading and the like. This allows higher production because multiple steps in the screen printing process can be carried out simultaneously. Further, the rotary press can be automated.

Single-item screen printing stations differ from rotary presses in that they hold one item at a time, and print one color at a time, and do not rotate about an axis. Because single-item screen printing stations only hold one item at a time, they are inefficient for producing multiple items with a single image and are therefore typically used for printing small runs.

Despite the advantages of screen printing, certain textiles do not screen print well. Dark textiles are the hardest to screen print because the ink is typically not opaque enough to completely conceal the color of the textile being printed. In order to resolve this problem, a light-color base is first printed onto the textile, which is referred to as an “underbase.” This underbase serves to block out the darker colored textile and enables other colors to be effectively screen printed on top of the underbase. Multi-colored shirts are typically screen printed in this manner. Although screen printing multi-colored shirts as discussed above is effective, it is time consuming and labor intensive as each color must be separately screen printed on the textile.

Another popular method of printing textiles is inkjet printing using inkjet printers. Inkjet printing involves forcing ink through tiny nozzles and, as a result, can produce finely detailed images. Inkjet printers function by moving an inkjet cartridge with a printhead back and forth over a substrate such as a textile. The printhead dispenses ink through a series of nozzles using known technologies such as thermal bubble jet, piezoelectric or valve jet dispensing mechanisms. Inkjet printing offers a number of potential benefits over conventional screen printing methods. Inkjet printing is computer controlled, and the digital printing eliminates the set-up expense associated with screen preparation thereby enabling cost-effective short-run production.

Inkjet printers are broadly categorized in two varieties: small and large format. Small inkjet printers (“small format printers”) print on a single, discrete item, such as a garment. Small format printers use printheads with smaller nozzles, typically bubble jet or piezoelectric, that dispense less ink than large format printers. Large inkjet printers (“large format printers”) print on continuous-feed substrates such as yard-goods, carpets, signs and banners. These large format printers use large nozzles, typically valve jets, for dispensing a large quantity of ink onto a substrate.

Small format printers are smaller and less expensive than large format printers. Small format printers are desirable because they can be incorporated with a rotary press thereby vastly reducing the amount of time required to print an image and increasing throughput. For example, instead of screen printing a three-color image onto a textile using three different stencils, one inkjet printer can print the entire three-color image directly onto the textile at a single station. This enables other stations to print other t-shirts at the same time. Another advantage of using an inkjet printer is that one can design an image on the computer using software such as Corel® Photoshop® software and send it directly to the inkjet printer; no laborious process of making screens is required.

Unfortunately, small format printers are currently not able to print light-colored ink (particularly white ink) efficiently. Inkjet printing with small format printers fails in this regard because typical inkjet textile ink layer is very thin and consequently transparent therefore not providing enough ink coverage on a dark textile. Moreover, printing with white ink is further complicated because the molecules of the white pigment, typically titanium dioxide, do not travel well through the inkjet nozzles of small format inkjet printers to produce an even spray. The only types of inkjet printers with large enough nozzles to accommodate white ink are large format printers, which use valve jets. Unfortunately, large format printers are designed to function solely in a linear manner, pulling continuous lengths of material through the printer, making it difficult to print images on discrete garments such as t-shirts. Further, because large format printers are so big, they are incapable of being used with a rotary press. As a result, garment printers have had to resort to screen printing to print white on dark textiles.

Another aspect of inkjet printing is the quest to print a highly-detailed image of intense colors, whether they are light-colored, white or darker colors. This has resulted in a number of inkjet print methods that vary the number of passes and the pattern of the ink dots on each pass. Multiple passes are used to print the highly detailed portions of an image with the smallest of ink dots used to print as highlights or faintly-colored shadows. Repeated passes create denser images and more intense colors. Repeated passes also serve to mitigate the impact of any malfunctioning ink ejection elements on the print quality. In a hybrid multi-drop and multi-pass printing system, composite drops are formed from separate drops merging onto the substrate, and highlight regions are formed by using single drops to form a dot. Individual drops are nearly invisible and thus can form highlights with low graininess. As the density of the image increases, multi-drop dots are formed by merging two or more drops. Drops merging together on the media cover unprinted space more efficiently, increase optical density without throughput loss and reduce ink ejection frequency.

When inkjet printing these rich detailed image on textiles in particular, methods are needed to overcome the simultaneous problems of high surface tension of textiles (compared to paper), which prevents ink from adhering well to the textile, and higher absorptivity, which causes the ink to disappear once it has been absorbed by the textile. Consequently, fabric is often pre-treated with a surfactant, followed by an underbase and then followed by printing the image in ink multiple times. The surfactant and the equipment applying it is necessarily rigorously separated from the ink and equipment supplying it, because the nature of the surfactant is to repel the ink. To inadvertently apply the surfactant and the ink with the same equipment would make the equipment malfunction.

On a single-textile printer, printing the image in ink multiple times necessitates causing the textile to make multiple passes under the printhead. Conventionally these repeated passes are initiated by a user pressing the “run” button each time another pass is required. It would be desirable to have an inkjet printer that automatically prints multiple passes on a garment, counts the number of passes, and displays them. It would further be desirable to have a method of loading a textile once and having it cycle through applying pre-treatment, applying an underbase, applying an image one or more times depending on what is needed and curing of the pre-treatment, underbase and image as needed.

Therefore, it is an object of the present invention to provide a method capable of inkjet printing white and other light-colored ink directly onto textiles with or without an underbase. It is a further object of this invention to provide a method of applying an underbase with an inkjet printer. It is also an object of the present invention to provide a method of applying images on textiles or other substrates using a rotary press having stations for pre-treatment, curing of pre-treatment, applying an underbase, curing an underbase, applying an image and curing an image. Finally, it is an object of this invention to provide a method of repeatedly applying an image and an underbase to a substrate or textile and counting and displaying the applications of the image.

### SUMMARY OF THE INVENTION

This invention is a method for printing light colors on dark textiles using combinations of screen printers, inkjet printers, pre-treatments and underbases. The method comprises screen printing a pre-treatment on the textile, followed by applying an underbase on the textile and then followed by inkjet printing the desired image on top of the underbase. In the preferred embodiment, a black t-shirt is placed on a platen of a rotary press. At a first station, a pre-treatment is screen printed onto the t-shirt. At a second station the pre-treatment is cured. At a third station, a white, opaque image is printed one or more times by inkjet onto the t-shirt to form the underbase. The platen is rotated to a fourth station where the inkjet ink is cured. The platen is next rotated to a fifth station where the desired image is printed one or more times by inkjet over the underbase. In another embodiment, a white, opaque underbase is screen printed onto a black t-shirt, followed by inkjet printing a light-colored image on top of the screen printed image. The preferred apparatus comprises a rotary speed table that cooperates with a screen printhead, one or more cure units, and one or more inkjet printheads employing pass counters.

### BRIEF DESCRIPTION OF THE DRAWINGS

FIG. 1A is a flow diagram of a first embodiment of this invention.

FIG. 1B is an illustration of the first embodiment of this invention using a rotary press.

FIG. 2 is a block diagram of an additional embodiment of this invention using a single-item print station.

FIG. 3 is a perspective view of a digital inkjet printer and a counter.

FIG. 4 is a schematic of the connections in a Keyence Counter model RC19.

### DETAILED DESCRIPTION OF THE INVENTION

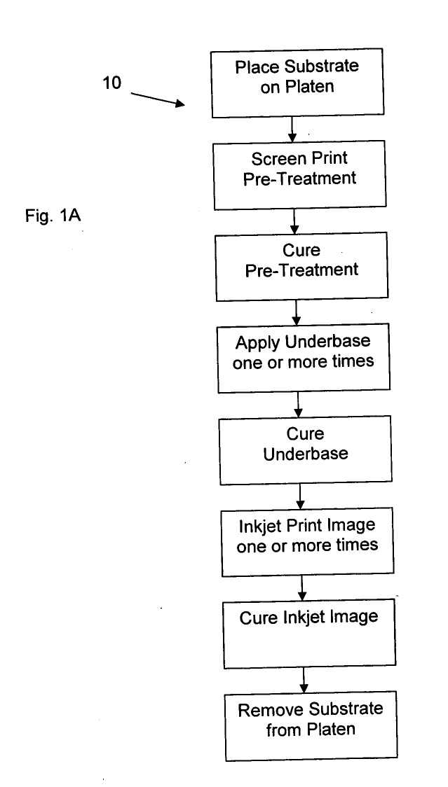

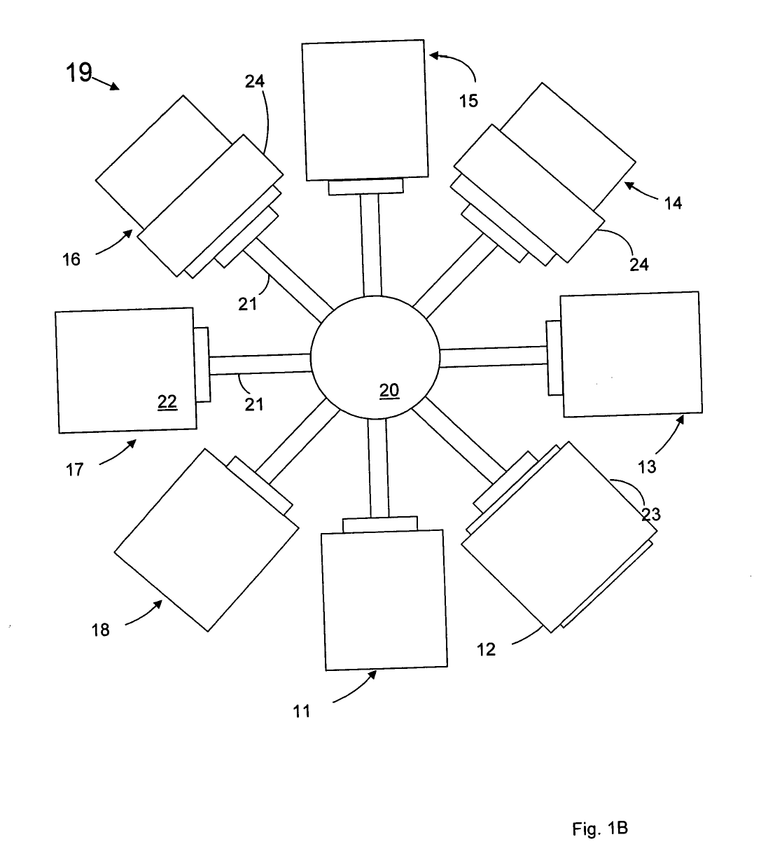

This invention combines screen printing with inkjet printing to print light colors on dark textiles and other substrates. The method of the present invention comprises screen printing a pre-treatment on a substrate; inkjet printing or screen printing a white, opaque underbase on a substrate; and inkjet printing the desired image over the underbase. In the preferred embodiments, traditional screen printing equipment is used in conjunction with one or more inkjet printers. Preferably, at least one of the inkjet printers uses valve jet nozzles allowing it to print white ink. Also preferably, at least one of the inkjet printers uses a pass counter with a display. While it is envisioned that the method of the present invention would be used primarily to print white or other light colors on dark textiles, dispensing white or light colored ink on any colored textile or any other substrate would still fall within the scope of the present invention. The method of the present invention is denoted as method 10, which is illustrated by FIG. 1A.

The first embodiment of method 10 uses a rotary press 19, which is illustrated in FIG. 1B. Rotary press 19 is preferably a speed table and comprises a base 20 with a series of arms 21 each of which supports a platen 22, which carries the textile being printed. As shown in FIG. 1B, platens 22 rotate about an axis of base 20 to enable each platen 22 to pass through a series of stations 11-18 wherein a different step in method 10 occurs. Method 10 will now be described in detail by way of example.

A textile item such as a garment is loaded on platen 22 of rotary press 19 at station 11. Platen 22 is rotated to station 12 wherein a pre-treatment solution is screen printed onto the textile by a screen printer 23 using known screen printing methods. An example of an acceptable pre-treatment solution is the inkjet ink-receptive pre-treatment solution T-Jet™ Pre-Treatment, available commercially from US Graphic Arts, Inc., Tempe, Ariz.

After the textile receives a pre-treatment, platen 22 is rotated to station 13 where the pre-treatment is cured. Curing is used herein to mean the hardening of the pre-treatment or ink, whether by evaporating solvent or polymerizing the pre-treatment or ink by heat or ultra-violet light, as is known in the art. In the preferred embodiment, a curing apparatus uses heat, such as that provided by a heat press, as is known in the art.

Platen 22 is then rotated to station 14 where either a screen printer (not shown) or a modified inkjet printer 24 applies an underbase to the textile. The underbase is a light color, such as white, is opaque and may be slightly smaller than the desired image, known in the art as “choking” the image. In the preferred embodiment, the underbase is applied using a modified inkjet printer 24 that is a small format printer modified to cooperate with a rotary press. Modified inkjet printer 24 may retain the smaller body of a small format printer while also including inkjet printheads that are capable of dispensing white ink. The ink dispensed by modified inkjet printer 24 can be any type of light-colored or white ink capable of forming an underbase, but it is anticipated that the ink is a solvent based ink, a platisol ink, or a UV curable ink. Preferably the white ink is Artistri White Ink for textiles, available from E.I du Pont de Nemours and Company. In the preferred embodiment, modified inkjet printer 24 would be in alignment with its respective station of the rotary press, as well as in substantially perfect registry from pass-to-pass to enable it to print an image two or more times on top of itself. Next, platen 22 is rotated to station 15 to cure the underbase. In the preferred embodiment, the curing apparatus is preferably a heat press.

After curing the underbase, platen 22 is rotated to station 16 wherein an image is inkjet printed onto the textile. The inkjet printing is preferably accomplished by using known equipment, such as a modified inkjet printer 25. An example of an excellent inkjet printer for use at station 16 is the FAST T-JET™ printer distributed by US Graphic Arts, Inc. of Tempe, Ariz. In this preferred embodiment, modified inkjet printer 24 would be in perfect registry to enable it to print the identical image two or more times to enhance the colors of the image. The ink used by modified inkjet printer 24 can be any known inkjet printer ink, an example of which is FASTINK™ ink, which is also produced and distributed by the U.S. Screen Printing Institute. Alternatively, especially when it is desired to print a white or light-colored image, modified inkjet printer 24 can have the smaller body of a small format printer while also including inkjet printheads with valve jets that are normally used in a large format printer and that are capable of dispensing white ink.

In alternative embodiments, multiple inkjet printers may be used at additional stations (not shown) to print additional ink onto the underbase. In that regard, each ink jet printer can print an identical image on the textile to enhance the trueness of the colors or each inkjet printer at each station may be dedicated to applying ink of a certain ink color to the textile. If additional stations are not desired, however, the user simply rotates platen 22 to a final station 17 to cure the inkjet ink. Curing of the inkjet ink at station 17 is accomplished in the same manner as curing the ink at station 15.

The textile is removed from platen 22 at a final station 18 after the above steps have been completed. In this preferred embodiment, the textile is an article of clothing such as a black t-shirt, a white underbase is applied with an inkjet printer, and the image applied over the underbase includes white.

Alternative embodiments of method 10 involve skipping certain steps or combining certain steps in certain circumstances. If eliminating steps temporarily, platen 22 could simply rotate past the stations where the eliminated step would have been performed. For example, if a pre-treatment is not desired, then both the step of applying the pre-treatment and curing the pre-treatment can be skipped. In that case, Platen 22 would be loaded at station 11 and then would proceed next to station 14. Similarly, if the underbase, the image or both do not need to be cured, the curing step or steps can be eliminated. Eliminating the curing steps is dependent upon which type of ink is printed onto the textile at stations 14 and 16, as is known in the art. In that case, platen 22 would rotate past either station 15, curing of the underbase, or station 17, curing of the image, or both. Alternatively, if eliminating any of these steps permanently, rotary press 19 could simply be designed without having stations for the eliminated steps.

It also may be desirable to eliminate the underbase altogether or to apply the underbase with the same inkjet printer that applies the image. In that case, modified inkjet printer 24 can have the smaller body of a small format printer while also including inkjet printheads with valve jets that are normally used in a large format printer and that are capable of dispensing white ink. Consequently, stations 14 and 15, applying the underbase and curing the underbase, can be eliminated altogether and the underbase and image can both be applied with modified inkjet printer 24, or the image can be printed with inkjet printer directly onto the textile with no underbase.

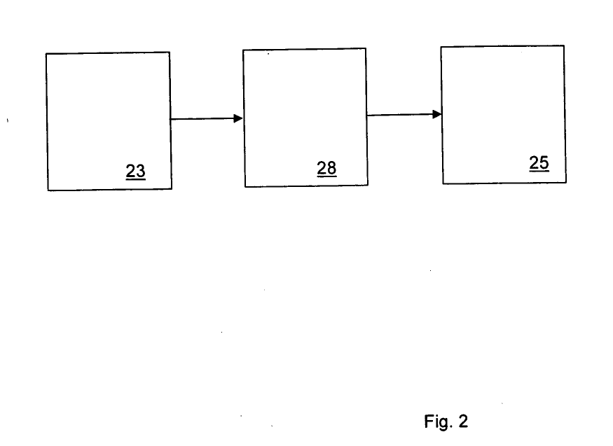

FIG. 2 illustrates an embodiment of method 10 where a rotary press is not used. Instead, the textile is printed at a single-item printing station. First, the textile is laid onto screen printing device 23. Then, using known methods, a pre-treatment is screen printed on the textile using screen printing device 23. The textile may be placed within a curing apparatus (not shown in FIG. 2) to cure the pre-treatment. Curing apparatus can be any known type of curing device, but in this preferred embodiment, curing apparatus uses heat. Then, then an underbase is printed on the textile with a printer 28. Printer 28 can be either a screen printing device or a stand-alone inkjet printer 25 that retains the smaller body of a small format printer. It includes inkjet printheads that can deliver white ink, which may inkjet printheads with valve jets that are normally used in a large format printer and that are capable of dispensing white ink. After the underbase is applied, the desired image is inkjet printed on top by inkjet printer 25. Similar to the embodiments already presented, inkjet printer 25 and printer 28 are preferably in alignment, and inkjet printer 25 is in substantially perfect registry from pass-to-pass to enable it to print an image two or more times on top of itself . Additionally, two or more inkjet printers could be used to print the image as discussed above in these embodiments.

In the embodiments described herein, the screen printers, inkjet printers and cure units may be stand-alone devices that operate independently, or they may be interconnected to cooperate with each other and the rotary press 19. Additionally, in the preferred embodiment, inkjet printers 24 and 25 have pass counters with displays that are capable of counting the number of applications of the underbase and the number of printings of the image and displaying that count for an operator to read.

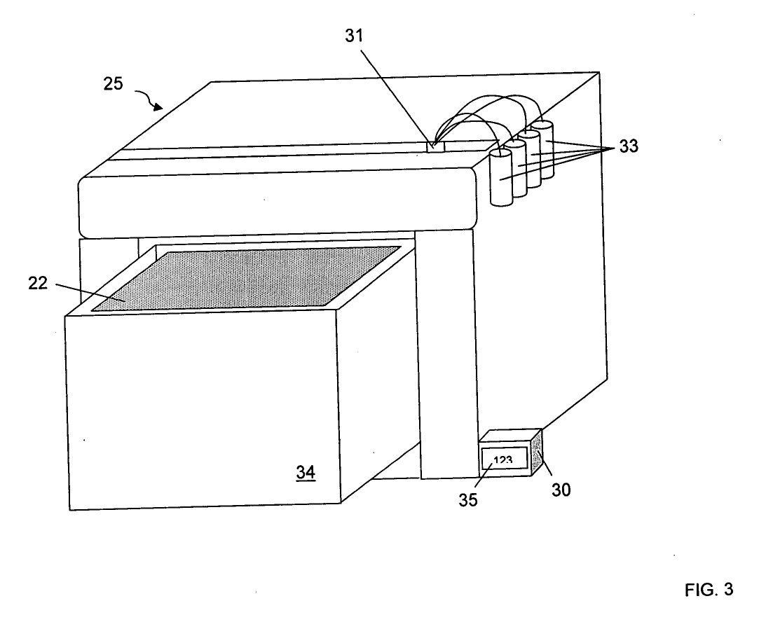

FIG. 3 is a perspective view of an inkjet printer with a pass counter, as is used in the preferred embodiment of method 10. Inkjet printer 25 comprises a printhead 31 further comprising a number of print nozzles 32 (not shown); ink reservoirs 33 connected to the nozzles 32; a carriage 34 that moves under the printhead 31; and a platen 22 that holds the garment (not shown) that receives the dispensed ink.

Inkjet printer 25 is a traditional small format printer for printing images on textiles, examples of which are the FAST T-JET™ inkjet printer or the FAST T-JET JUMBO™ inkjet printer, both of which are distributed by the U.S. Graphic Arts of Tempe, Ariz. Inkjet printer 25 can also be a modified small format inkjet printer that uses large format printer valve jets such as inkjet printer 24. In the preferred embodiment, inkjet printer 25 is in substantially perfect registry to enable it to print the identical image two or more times to enhance the colors of the image.

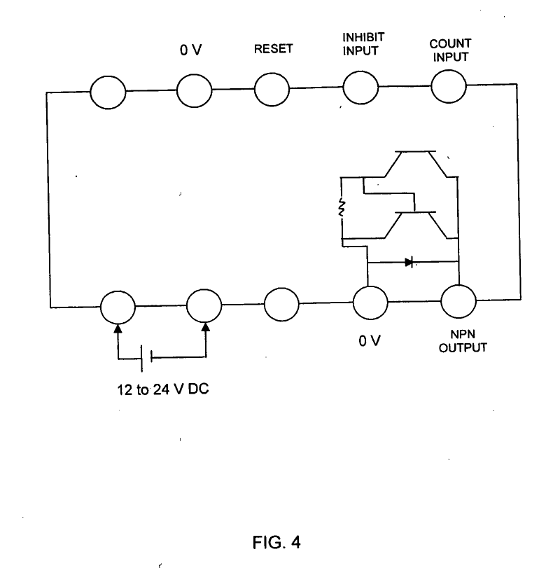

The counter 30 is an electronic counter having a display 35 that shows the number of passes counted. The input is preferably a non-voltage input, such as contact or solid state input, such as a light sensor or a motion sensor. These devices are available commercially, such as the RC-18 LED or RC-19 LED electronic counter from Keyence. Alternatively, a programmable logic controller may be used with voltage inputs. In the preferred embodiment, the counter is wired into the printer's circuit board such that the counter receives power from the same source as the printer and can interrupt printer commands, thereby causing the printer to rewind and make multiple dispensing passes without human intervention. FIG. 4 shows the connections of Keyence Counter model RC19.

Platen 22 holds a textile (not shown) such as a t-shirt, shorts, underwear, outerwear or other clothing. Similarly, any substrate can be placed on platen 22 as well. Platen 22 passes under printhead 31 from a starting point, and the desired substance and pattern is printed on the textile. Counter 30 is electrically connected to inkjet printer 25 such that each time carriage 34 passes from a starting point to an endpoint, counter 30 is incremented. In the preferred embodiment, counter 30 has a light sensor such that as carriage 34 passes to the endpoint and blocks light entering counter 30, counter 30 is incremented. Alternatively, counter 30 has a motion sensor such that as carriage 34 passes to the endpoint, the motion is sensed thereby incrementing counter 30.

If more than one pass is desired, when carriage 34 reaches the endpoint, counter 30 automatically resets and carriage 34 is returned to its starting point. Preferably carriage 34 moves back and forth under printhead 31 on the same linear path, in forward and reverse (or “rewind”) passes. Preferably the substance is dispensed on the forward pass only, but alternatively it can be dispensed on the reverse pass or both the forward and reverse passes. Alternatively, carriage 34 can move in a single direction under printhead 31 in a continuous motion, such as in a clockwise or counterclockwise circular path on a conveyor. After completing the desired number of passes, carriage 34 stops and remains at its endpoint.

In a preferred embodiment, where the underbase and image are inkjet printed by the same inkjet printer 25, when platen 22 reaches station 16, multiple passes are used to print a light image on a dark t-shirt. Counter 30 is set for a predetermined number of passes that correspond with the print command. Carriage 34 makes a total of six passes under printhead 31 while it is dispensing: three passes, each a white ink underbase, followed by three passes of the full color ink to create the desired image. Carriage 34 passes under printhead 31, and a first pass of white ink is dispensed on the garment. During or near the end of the pass, counter 30 is triggered, and the numeral “1” is displayed on display 35 of the counter 30. Carriage 34 automatically returns to its original position and again starts its motion under printhead 31, and a second pass of white ink is dispensed on the garment. During or near the end of the second pass, counter 30 is triggered, and the numeral “2” is displayed on display 35. Carriage 34 again automatically returns to its original position, and the process is repeated for the third pass of white ink. During or near the end of the third pass, counter 30 is triggered, and the numeral “3” displays on display 35. The carriage again automatically returns to its original position, except this time colored ink will be dispensed on the garment. Again, carriage 34 moves under printhead 31 and then, during or near the end of this fourth pass, counter 30 is triggered, and the numeral “4” is displayed on display 35. The process is repeated for a second pass of color, after which display 35 shows a “5,” and finally a third pass of color after which display 35 shows “6.” Then, carriage 34 automatically moves to the next station of the rotary press or to a position to allow the user to remove the textile. The user can tell from the display that the textile has completed six passes.

In an alternative embodiment, carriage 34 again makes a total of six passes under printhead 31 while it is dispensing: three passes, each a white ink underbase, followed by three passes of the full color ink to create the desired image. However, counter 30 increments from “1” to “3” for each of the three underbase passes and then resets itself so that counter 30 increments again from “1” to “3” for each of the three color passes. In this manner the user can determine the number of passes of each dispensed substance. If desired, counter 30 can also display the number of passes dispensing each substance as well as the total number of passes.

In yet another embodiment, the underbase is eliminated and the desired image is printed directly onto the textile in white or other light-colored ink. Specifically, carriage 34 makes a total of two passes under printhead 31 while it is dispensing, each a pass of the full image to create the desired image. Conversely, in another example, for some shirts where there is a lot of ink coverage, there may be three passes of white ink and then one pass of the colored ink. This would be four passes, and accordingly the counter would be set to four to match the print command.

As can be seen, method 10 provides for an efficient process of printing light-color images on dark substrates such as textiles. Light-color inks and white ink can be easily applied to dark textiles such as black t-shirts with relative ease by combining screen printing with inkjet printing. Using modified small format printers capable of dispensing white ink for an underbase, using a screen printer to apply a pre-treatment to a textile and employing pass counters to accurately control and identify the number of passes an inkjet printer makes over the textile all enhance the process of applying a light-color or white image to a dark textile.

While there has been illustrated and described what is at present considered to be the preferred embodiment of the present invention, it will be understood by those skilled in the art that various changes and modifications may be made and equivalents may be substituted for elements thereof without departing from the true scope of the invention. Therefore, it is intended that this invention not be limited to the particular embodiment disclosed, but that the invention will include all embodiments falling within the scope of the appended claims.

We claim:

1. A method of printing an image on a substrate comprising:
a) inkjet printing an underbase on the substrate; and
b) inkjet printing a white image on top of the underbase.

2. The method according to claim 1 wherein the textile is placed on a rotary press and remains on the rotary press during the inkjet printing.

3. The method according to claim 1 further comprises screen-printing a pre-treatment on the substrate.

4. The method according to claim 1 wherein the substrate is a black textile.

5. The method according to claim 1 further comprising inkjet printing the image again at least one time and counting each printing of the image.

6. A method of printing an image on a substrate comprising:
a) screen printing a pre-treatment on the substrate;
b) applying an underbase on the substrate; and
c) inkjet printing an image on top of the underbase.

7. The method according to claim 6 wherein the underbase is screen-printed.

8. The method according to claim 6 wherein the image inkjet printed on top of the underbase is white.

9. The method according to claim 6 wherein the substrate is a black textile.

10. The method according to claim 6 further comprising inkjet printing the image again at least one time and counting each printing of the image.

11. The method according to claim 6 wherein the textile is placed on a rotary press and remains on the rotary press until after the image has been inkjet printed.

12. A method of printing an image on a substrate comprising:
a) inkjet printing an image at least once on the substrate; and
b) counting each printing of the image.

13. The method according to claim 12 further comprising displaying the count of printings of the image.

14. The method according to claim 12 wherein each inkjet printing of the image is counted using a motion sensor.

15. The method according to claim 12 wherein each inkjet printing of the image is counted using a light sensor.

16. The method according to claim 12 further comprising:
a) programming an inkjet printer to print the underbase a specified number of times; and
b) programming an inkjet printer to print the image a specified number of times.

17. The method according to claim 12 wherein the substrate is placed on a rotary press and remains on the rotary press during the inkjet printing.

18. The method according to claim 12 wherein the image printed is white.

19. The method according to claim 12 wherein the substrate is a black textile.

20. A method of printing a white image on a substrate comprising:
a) disposing the substrate such that the substrate can receive an image from an inkjet printer having valve jets capable of dispensing white ink; and
b) inkjet printing the white image on the substrate at least one time.

21. The method according to claim 20 further comprising counting each inkjet printing of the white image.

22. The method according to claim 20 further comprising programming the inkjet printer to inkjet print the white image a specified number of times.

23. The method according to claim 20 wherein the substrate is a black textile.
